(19) United States
(12) Patent Application Publication
(10) Pub. No.: US 2002/0062191 A1
(43) Pub. Date: May 23, 2002

(54) Information offering method and apparatus for vehicle

(75) Inventor: Takuma Yanagisawa, Tsurugashima-shi (JP)

Correspondence Address: SUGHRUE, MION, ZINN, MACPEAK & SEAS, PLLC, Suite 800, 2100 Pennsylvania Avenue, N.W., Washington, DC, 20037-3213, US

(73) Assignee: PIONEER CORPORATION

(21) Appl. No.: 09/965,887

(22) Filed: Oct. 1, 2001

(30) Foreign Application Priority Data
Sep. 29, 2000 (JP) 2000-298389

(51) Int. Cl. G06G 7/70

(52) U.S. Cl. 701/123; 701/1

(57) ABSTRACT

An information offering apparatus for a vehicle includes: a device for setting at least one piece of vehicle information relating to fuel consumption of a vehicle, the vehicle information being output from a vehicle information detector when a predetermined time elapses after the beginning of use of the vehicle; a device for calculating a histogram of vehicle information or a standard deviation during the use of the vehicle based on the set vehicle information; a device for marking the vehicle information based on a point set in the histogram or the standard deviation; a device for calculating an evaluation result based on the point of each of the marked vehicle information; and an notifying device for notifying a driver of the evaluation result.

### BACKGROUND OF THE INVENTION

1. Field of the Invention

The present invention relates to information offering method and apparatus for a vehicle and, more particularly, to information offering method and apparatus for a vehicle in which information is notified to the driver based on the driving situation of a vehicle.

2. Description of Related Art

A vehicle driving manner depends upon a driver. In particular, there are a variety of patterns of driving situation case by case. A variety of patterns of the driving situation influences the quantity of fuel consumed by the driving.

Fuel consumption or emission of exhaust gas such as carbon dioxide caused by the fuel consumption considerably imparts adverse effects on terrestrial environment. Some driving situations put relatively small adverse effects on the terrestrial environment, and they are therefore called ecologically friendly driving situations. In contrast, there are other driving situations that impart considerable adverse effects on the terrestrial environment.

Moreover, there has been a socially growing interest in the issues of the terrestrial environment in recent years. Therefore, in driving a vehicle such as an automobile, there have been increased needs for the ecologically friendly driving between people.

However, under the current circumstance, there has been no appropriate method which advises a driver his or her driving manner in respect of the terrestrial environment on the real time basis, in particular, the evaluation as to whether or not the driver drives in an ecologically friendly manner.

### SUMMARY OF THE INVENTION

Thus, an object of the present invention is to provide an information offering method and apparatus for a vehicle, in which in order to assist a driver to drive a vehicle in an ecologically friendly manner, a driving situation is evaluated as to whether or not the driver drives the vehicle in an ecologically friendly manner, and then the driver is notified of the evaluation result.

According to one aspect of the present invention, there is provided an information offering method for a vehicle including the steps of: calculating a histogram of vehicle information or a standard deviation during use of a vehicle based on at least one of vehicle information relating to fuel consumption of the vehicle, the vehicle information being output from a vehicle information detector when a predetermined time elapses after a beginning of the use of the vehicle; marking the vehicle information based on a point set in the histogram or the standard deviation; and calculating an evaluation result based on the point of each of the marked vehicle information to notify a driver of the calculated evaluation result.

According to similar aspect of the present invention, there is provided an information offering apparatus for a vehicle including: a device for setting at least one of vehicle information relating to fuel consumption of a vehicle, the vehicle information being output from a vehicle information detector when a predetermined time elapses after the beginning of use of the vehicle; a device for calculating a histogram of vehicle information or a standard deviation during the use of the vehicle based on the set vehicle information; a device for marking the vehicle information based on a point set in the histogram or the standard deviation; a device for calculating an evaluation result based on the point of each of the marked vehicle information; and a notifying device for notifying a driver of the evaluation result.

In accordance with the above method and apparatus, at least one of vehicle information relating to fuel consumption of a vehicle is set, and the vehicle information is output from a vehicle information detector when a predetermined time elapses after the beginning of use of the vehicle. Then, a histogram of vehicle information or a standard deviation during the use of the vehicle is calculated based on the set vehicle information. The vehicle information is marked based on a point set in the histogram or the standard deviation, and an evaluation result is calculated based on the point of each of the marked vehicle information. Thereafter, the evaluation result is notified to a driver.

According to another aspect of the present invention, there is provided an information offering method for a vehicle including the steps of: detecting a first vehicle speed pulse output from a vehicle speed pulse sensor during use of a vehicle and a second vehicle speed pulse output from the vehicle speed pulse sensor when a predetermined time elapses after the beginning of the use of the vehicle; calculating a histogram of vehicle information or a standard deviation based on at least one of vehicle information relating to fuel consumption of the vehicle from the first vehicle speed pulse and the second vehicle speed pulse; marking the vehicle information based on a point set in the histogram or the standard deviation; and calculating an evaluation result based on the point of each of the marked vehicle information to notify a driver of the calculated evaluation result.

According to the similar aspect of the present invention, there is provided an information offering apparatus for a vehicle including: a device for detecting a first vehicle speed pulse output from a vehicle speed pulse sensor during use of a vehicle and a second vehicle speed pulse output from the vehicle speed pulse sensor when a predetermined time elapses after the beginning of the use of the vehicle; a device for calculating a histogram of vehicle information or a standard deviation based on at least one of vehicle information relating to fuel consumption of the vehicle from the first vehicle speed pulse and the second vehicle speed pulse; a device for marking the vehicle information based on a point set in the histogram or the standard deviation; a device for calculating an evaluation result based on the point of each of the marked vehicle information; and an notifying device for notifying a driver of the evaluation result.

In accordance with the above method and apparatus, a first vehicle speed pulse output from a vehicle speed pulse sensor is detected during use of a vehicle, and a second vehicle speed pulse output from the vehicle speed pulse sensor is detected when a predetermined time elapses after the beginning of the use of the vehicle. Then, a histogram of vehicle information or a standard deviation is calculated based on at least one of vehicle information relating to fuel consumption of the vehicle from the first vehicle speed pulse and the second vehicle speed pulse. The vehicle information is marked based on a point set in the histogram or the standard deviation, and an evaluation result is calculated based on the point of each of the marked vehicle information. Then, the evaluation result is notified to a driver.

In an example, the evaluation result may include an evaluation result of the driving situation of the vehicle.

In a preferred embodiment, the vehicle information detector may include at least any one of a vehicle speed sensor, an acceleration sensor and a distance sensor.

In a preferred embodiment, the vehicle information may include at least any one of a traveling distance, an idling time, a traveling speed and an acceleration of the vehicle.

Further, the marking of the vehicle information may be performed in consideration of the quantity of fuel consumption, the quantity of exhaust gas emitted, or components of the exhaust gas of the vehicle during the use of the vehicle.

In a specific embodiment, the notifying device may include at least either one of a display and a sound output unit mounted on the vehicle.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIG. 1 is a block diagram illustrating the configuration of an information offering apparatus according to a first preferred embodiment of the present invention;

FIG. 2 is a block diagram illustrating the configuration of an information offering apparatus in according to a second preferred embodiment of the present invention;

FIG. 3 is a flowchart illustrating a processing routine for evaluating a traveling distance of a vehicle according to the first preferred embodiment of the present invention;

FIG. 4 is a flowchart illustrating a specific processing routine for calculating a traveling distance composing ratio according to the first and second preferred embodiments of the present invention;

FIG. 5 is a flowchart illustrating a processing routine for evaluating the idling time, the traveling speed and the acceleration of the vehicle according to the first preferred embodiment of the present invention;

FIG. 6 is a flowchart illustrating a specific processing routine for calculating a traveling speed composing ratio according to the first and second preferred embodiments of the present invention;

FIG. 7 is a flowchart illustrating a specific processing routine for calculating an acceleration standard deviation according to the first and second preferred embodiments of the present invention;

FIG. 8 is a flowchart illustrating a processing routine for evaluating a traveling distance of a vehicle according to the second preferred embodiment of the present invention;

FIG. 9 is a flowchart illustrating a processing routine for evaluating the idling time, the traveling speed and the acceleration of the vehicle according to the second preferred embodiment of the present invention;

FIG. 10 illustrates an example of a histogram of a traveling distance parameter vs. a composing ratio and an average traveling distance according to the first and second preferred embodiments of the present invention;

FIG. 11 illustrates an example of a histogram of a traveling speed parameter vs. a composing ratio and an average traveling speed according to the first and second preferred embodiments of the present invention;

FIG. 12 illustrates an example of a traveling speed monitor according to the first and second preferred embodiments of the present invention;

FIG. 13 illustrates an example of an acceleration monitor according to the first and second preferred embodiments of the present invention; and

FIG. 14 is a flowchart illustrating another specific processing routine for calculating a traveling distance composing ratio according to the first and second preferred embodiments of the present invention.

### DETAILED DESCRIPTION OF THE PREFERRED EMBODIMENTS

Referring to the attached drawings, detailed descriptions will be given below of preferred embodiments of the present invention.

The information offering apparatus for a vehicle according to the present invention is applied to a navigation system which provides route assisting information to the driver via an image or a sound. The information offering apparatus for a vehicle displays an image screen representing an evaluation result of a driving situation of a driver with respect to the terrestrial environment and/or provides the evaluation result to the driver in the form of sound.

[1st Embodiment]

(Configuration)

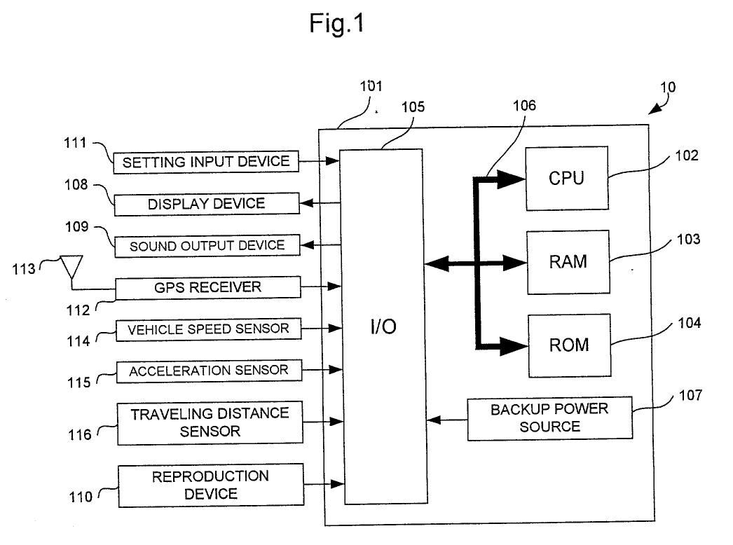

As illustrated in FIG. 1, a navigation system 10 according to the first embodiment includes an apparatus body 101 and a microcomputer including a CPU 102, a RAM 103, a ROM 104 and an input/output port (I/O) 105, wherein the constituent elements of the microcomputer are connected to each other via a bus 106 in such a manner as to freely transmit or receive a command or data. Incidentally, the RAM 103 is a backup RAM which holds therein the contents of stored information even during power-down.

The ROM 104 stores therein programs for the processing routines described later and graphics format for displaying evaluation results of a driving situation of a driver. Here, the ROM 104 may be any type of medium, such as a hard disk, that has the function of storing the programs and the graphical format for displaying the evaluation result of a driving situation of a driver.

Use of a backup power source 107 enables the evaluation result of the driving situation to be calculated and notified to the driver after the driver stops the engine of the vehicle. Without any backup power source, the system calculates and notifies the evaluation result up to the previous drive after the driver starts the engine at the time of the next drive. In comparison with such a system, the additional use of the backup power source 107 enables the driver to confirm the evaluation result of his or her driving situation at real time immediately after finishing the driving.

It is noted that the navigation system 10 according to the present embodiment can be connected to a local area network for a vehicle via the input/output port 105.

To the input/output port 105 are connected a display device 108 for offering route information to the driver in the form of images, a sound output device 109 for offering the route information to the driver in the form of sound, and a reproduction device 110 for reproducing a route information recording medium, not illustrated, such as a CD-ROM or a DVD-ROM, on which the route information is recorded.

The display device 108 can display map information supplied from the reproduction device 110 as well as the evaluation result of the driving situation of the driver, as described later. The sound output device 109 converts a sound signal output from the apparatus body 101 into a drive signal for a speaker (not illustrated) additionally attached to the sound output device 109, and then outputs the drive signal. The sound output device 109 can notify the evaluation result of the driving situation of the driver via sound, as described later.

The route information recording medium to be loaded in the reproduction device 110 stores therein information on a route from a current position of the vehicle to a destination, the map information geographically expressing the route and its surroundings in the form of a database, and information on the surroundings of a traveling route in association with the map information, for example, a vehicle speed limit, positions of pedestrian crossovers or railroad crossings, or types of roads such as national highways and expressways in the form of a database.

To the input/output port 105 are connected vehicle information detectors for receiving vehicle information relating to fuel consumption of the vehicle. The vehicle information detectors include a vehicle speed sensor 114, an acceleration sensor 115 and a traveling distance sensor 116.

The vehicle speed sensor 114 is connected to a speed meter or the like of the vehicle and detects the traveling speed of the vehicle during traveling. The acceleration sensor 115 is adapted to detect an acceleration of the vehicle. The traveling distance sensor 116 is connected to a traveling distance meter or the like of the vehicle and detects the traveling distance of the vehicle.

The vehicle information relating to the fuel consumption of the vehicle includes the traveling distance, the idling time, the traveling speed, the acceleration and the like of the vehicle.

Furthermore, to the input/output port 105 is connected a setting input device 111, which is an input device for setting the evaluation condition of the driving situation with respect to the terrestrial environment by using, for example, a keyboard or a switch. When the driver or the like sets the evaluation condition in the setting input device 111, the information on the evaluation condition is input into the RAM 103 through the input/output port 105 and the bus 106. In the present embodiment, a predetermined time for capturing, into the CPU 102 or the RAM 103, the vehicle information relating to the fuel consumption of the vehicle is set. The vehicle information relating to the fuel consumption is output from the vehicle information detectors such as the vehicle speed sensor 114, the acceleration sensor 115 and the traveling distance sensor 116. The CPU 102 has, in advance, a program for obtaining the vehicle information within the predetermined time. The RAM 103 receives a specific time value from the setting input device 111, and temporarily stores it therein. The CPU 102 reads out the predetermined time from the RAM 103 via the bus 106, and obtains the vehicle information from the vehicle information detectors every time the predetermined time elapses.

The CPU 102 has several threshold values for each vehicle information, classifies the read vehicle information into parameters, and then calculates the evaluation result of the driving situation in accordance with the processing routine descried later. The specific threshold values are input via the setting input device 111 by the driver. The values thus input are temporarily stored in the RAM 103 via the input/output port 105 and the bus 106. The CPU 102 reads the specific threshold values input into the RAM 103 via the bus 106. Thereafter, the CPU 102 calculates the evaluation result of the driving situation in accordance with the processing routine descried later by using the specific threshold values thus input as the reference values.

Additionally, to the input/output port 105 is connected a GPS receiver 112 having a GPS antenna 113. The GPS receiver 112 receives radio waves from geodetic satellites in a satellite orbit via the GPS antenna 113. Thus, the latitude and longitude of the current position of the vehicle are calculated based on the received radio waves.

(Evaluation of Traveling Distance)

Next, explanation will be made below on the processing routine relating to the traveling distance of the vehicle to be executed in the navigation system 10 with reference to the drawings.

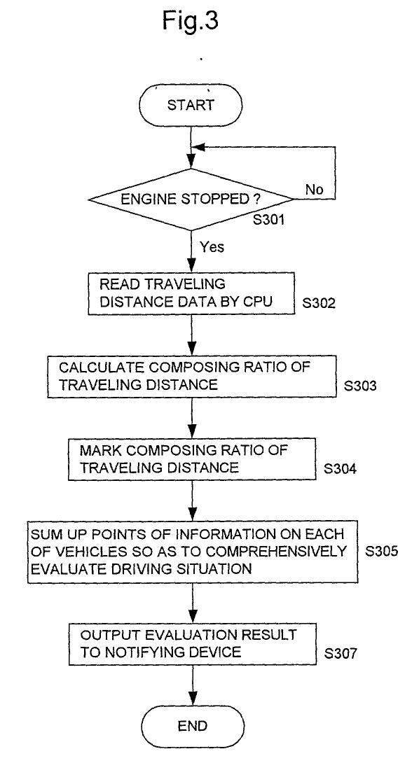

FIG. 3 is a flowchart illustrating the processing routine for evaluating the traveling distance of the vehicle in the navigation system 10 of FIG. 1 according to the first embodiment.

The processing routine illustrated in FIG. 3 is started in the navigation system 10 immediately after the start of the engine of the vehicle. After starting the engine, it is judged in step S301 whether or not the engine of the vehicle is stopped. The predetermined time for detecting traveling distance data is set to the time period from the start of the engine to the stoppage thereof. If the CPU 102 recognizes the stoppage of the engine in step S301, the routine proceeds to next step S302.

In step S302, the CPU 102 obtains the traveling distance data from the traveling distance sensor 116 via the input/output port 105 and the bus 106. In this step, the CPU 102 for performing arithmetic processing obtains the traveling distance data per driving of the vehicle for the first time, and become possible to use the traveling distance data. The traveling distance data obtained from the start of the engine to the stoppage thereof, which has been input into the CPU 102, is subjected to the arithmetic processing in step S303 in accordance with a preset routine.

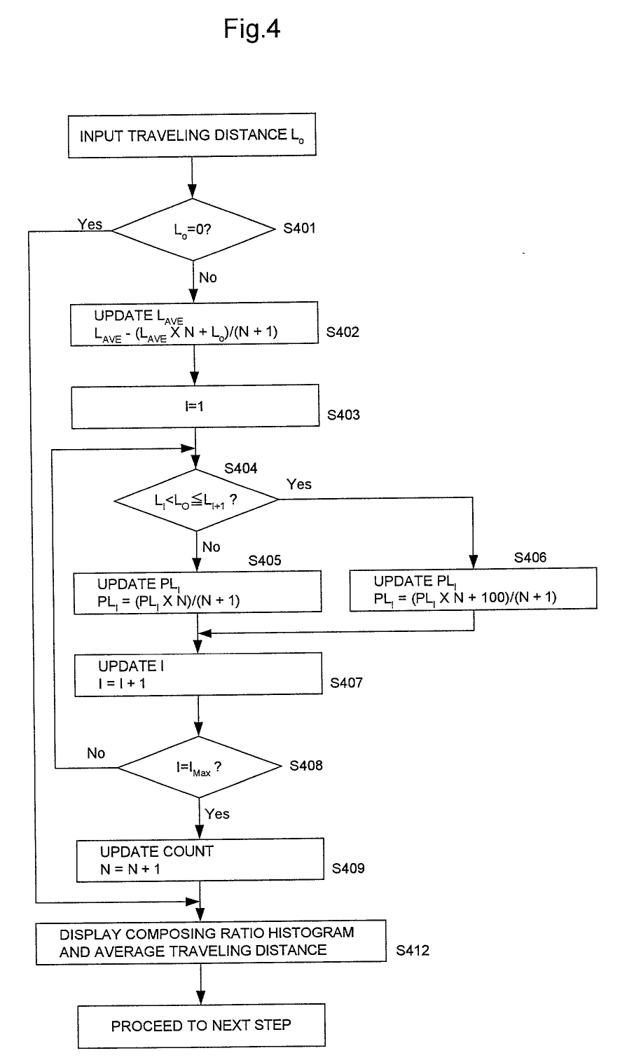

A specific example of the processing performed in step S303 will be described in reference to FIG. 4.

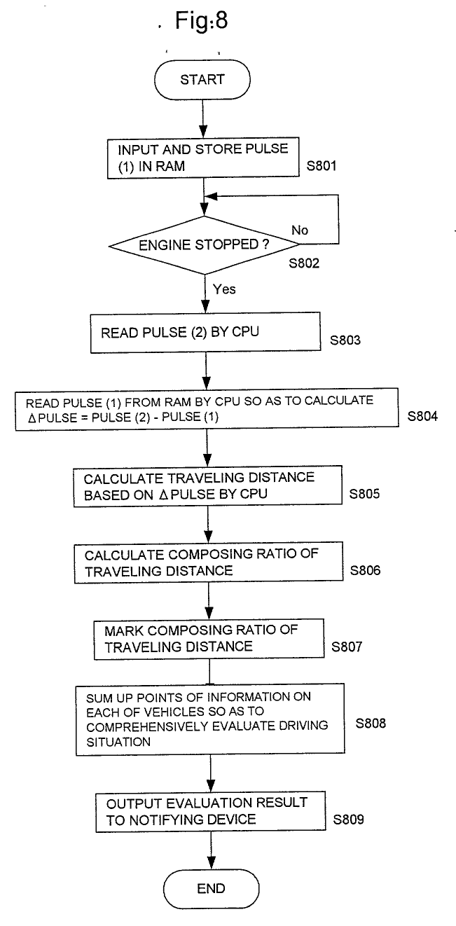

FIG. 4 is a flowchart illustrating a specific processing routine which calculates a histogram based on the classification of the traveling distance data into parameters in the CPU 102 and calculates a composing ratio representing the frequency of each of the parameters in the histogram in step S303 of FIG. 3 and step S806 of FIG. 8 described later.

It is judged in step S401 whether or not the traveling distance data Lₒ input into the CPU 102 is 0. Namely, it is judged in this step whether the vehicle travels, that is, Lₒ≠0 or the vehicle does not travel, that is, Lₒ=0. This step is a preparation step to calculate the composing ratio in the histogram of the traveling distance, described later. If Lₒ=0, the routine jumps to step S412. If Lₒ≠0, the routine proceeds to step S402.

In step S402, an average traveling distance L_{Ave} obtained by averaging the traveling distances sampled from the initial sampling to this sampling is updated. Specifically, the average traveling distance L_{Ave} is calculated in accordance with the following expression:

L_{Ave}=(L_{Ave}×N+Lₒ)/(N+1),

wherein reference character N in step S402 represents the number of sampled pieces of traveling distance data up to the previous sampling.

In next step S403, I is defined to be 1, wherein the reference character I represents a variable required, after step S404, for identifying one of a plurality of classified parameters to which the traveling distance data belongs to.

In next step S404, an actual identification judgement is made as to which parameter the traveling distance data Lₒ belongs. Specifically, it is judged whether or not the traveling distance data Lₒ is greater than L_{I} and not larger than L_{I+1}, that is, it ranges within the parameter of L_{I}<Lₒ≦L_{I+1}. In other words, it is first judged in this routine whether or not L₁<Lₒ≦L₂ in sequence based on I which is defined to be 1 in step S403.

Here, in the present embodiment, it is assumed that the user sets by the setting input device 111 such that, for example, a maximum value I_{Max}=6 and L₁=0, L₂=1, L₃=2, L₄=5, L₅=10 and L₆=20. Namely, it is judged in this routine whether or not the traveling distance data Lₒ satisfies: 0<Lₒ≦1.

It is noted that I_{Max} represents the total number of classified parameters; each of L₁, L₂, . . . L_{I} represents an upper limit value and a lower limit value of the range of each parameter, which can be changed by the setting input device 111. L_{I+1} is desirably set to a large value since the range of the maximum parameter is expressed to be L_{I} or greater at the time of the evaluation result. For example, L₇ as L_{I+1} is set to be 99999 in the present embodiment.

Subsequently, the composing ratio PL_{I} (%) is updated in step S405 or step S406. The composing ratio PL_{I} represents the ratio of the number of parameters with respect to the total sampling number up to this sampling.

If it is judged in step S404 that Lₒ belongs to the parameters from L₁ to L₂, namely, it is judged that L₁<Lₒ≦L₂, the routine proceeds to step S406, in which the composing ratio PL_{I} of the parameter ranging within L₁<Lₒ≦L₂ is updated, and then the routine proceeds to step S407. In contrast, unless it is judged that Lₒ belongs to the parameters from L₁ to L₂, namely, unless it is judged that L₁<Lₒ≦L₂, the routine proceeds to step S405. In step S405, the composing ratio PL_{I} of the parameter ranging within L₁<Lₒ≦L₂ is updated, and then the routine proceeds to step S407.

Here, the composing ratio PL_{I} in the case where it is judged in step S404 that the value Lₒ is greater than L₁ and not greater than L₂, namely, L₁<Lₒ≦L₂, is calculated in step S406. In contrast, the composing ratio PL_{I} in the case where it is not judged in step S404 that the value Lₒ is greater than L₁ and not greater than L₂, namely, it is not judged that L₁<Lₒ≦L₂, is calculated in step S405.

In next step S407, the value I is updated as I+1. Step S407 in which the value I is updated is a preparation step to determine the composing ratio PL_{I} of the next parameter in subsequent steps. In this routine in the present embodiment, I is updated to be 2, and then the routine proceeds to next step S408.

In next step S408, it is judged whether or not the value I updated in step S407 is equal to I_{Max}. If it is judged in step S408 that I=I_{Max}, it signifies that the composing ratios PL_{I} for all parameters are updated. In other words, step S408 is a step in which it is judged whether or not all of the composing ratios PL_{I} have been updated. It is judged that I is not equal to I_{Max} since I_{Max} is set to be 6 in the present embodiment, the routine returns to step S404.

Subsequently, in step S404 again, it is judged based on L_{I}<Lₒ≦L_{I+1} whether or not the traveling distance Lₒ belongs to the parameters ranging within L₂<Lₒ ≦L₃. In the present embodiment, it is judged whether or not 1<Lₒ≦2.

In this manner, the routine is repeated from step S404 to step S408 until I reaches I_{Max}, that is, until the composing ratios PL_{I} for all of the parameters are updated. Consequently, the traveling distance Lₒ is classified in to any one range out of L₁<Lₒ≦L₂, L₂<Lₒ≦L₃, . . . L_{Imax}<Lₒ≦L_{Imax+1}, that is, to any one parameter. Thus, each of the composing ratios PL₁, PL₂ . . . PL_{Imax} is updated in step S405 or step S406.

When it is judged in step S408 that I=I_{Max}, that is, when the composing ratios PL_{I} for all of the parameters are updated, the routine proceeds to step S409.

In step S409, the total sampling number N up to the previous sampling is incremented by 1. Namely, the calculation in accordance with the expression of N=N+1 is performed, and thus N is updated as the total sampling number inclusive of this sampling.

In next step S412, the histogram of the traveling distance parameter vs. the composing ratio is produced based on each of the composing ratios obtained based on the data processed in step S401 to step S409, and then it is displayed on the display device 108 in the form of an image. Furthermore, the average traveling distance obtained in step S402 is also displayed on the display device 108 in the form of an image together with the histogram of the traveling distance parameter vs. the composing ratio. In this case, the CPU 102 outputs the image data to the display device 108 through the bus 106 and the input/output port 105, and then the display device 108 displays the data in the form of the images.

Although FIG. 4 illustrates the processing routine for making the histogram of the traveling distance parameter vs. the composing ratio with respect to all of the traveling distance-data sampled up to now, the histogram of the traveling distance parameter vs. the composing ratio may be produced for the traveling distance data limited from this sampling to the predetermined number of past samplings.

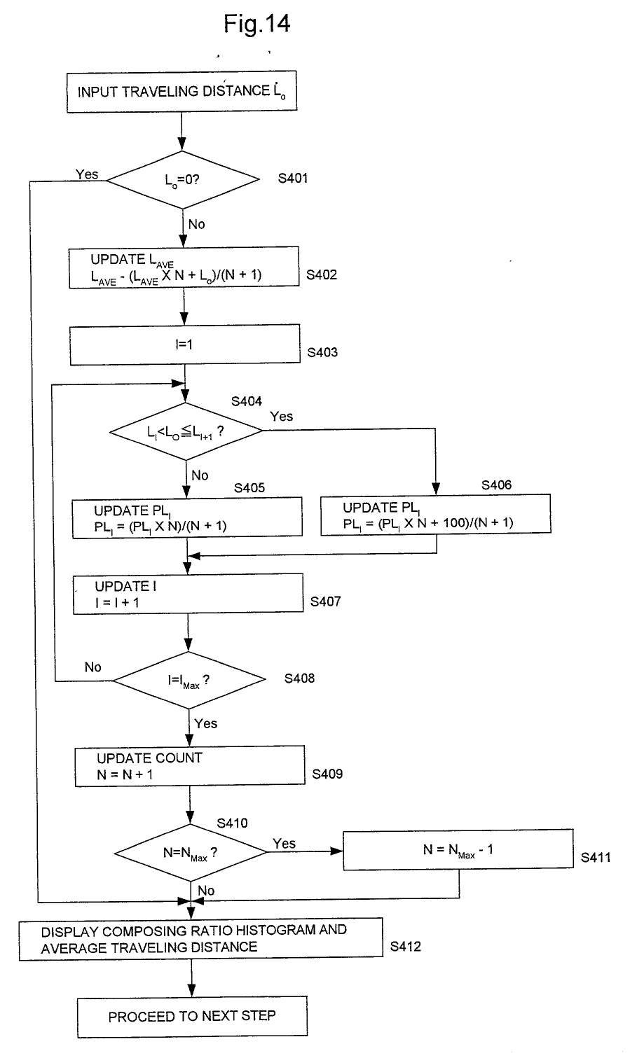

A specific example for this will be explained with reference to FIG. 14. The processing from step S401 to step S409 is performed in the same manner as that in FIG. 4. Upon completion of step S409, the routine proceeds to step S410.

In step S410, it is judged whether or not the sampling number N updated in step S409 is equal to N_{Max}, wherein N_{Max} represents the sampling number inclusive of this sampling, set in the case where the results of traveling distance data of the recent sampling number N_{Max} are obtained with a limitation, and it can be freely set by the user using the setting input device 111. Setting N_{Max} enables the composing ratios of the late sampling number N_{Max} to be obtained in addition to the total composing ratio of the traveling times.

For example, in order to obtain the result of recent 50 traveling distance data inclusive of this data, N_{Max} is set to be 50. Consequently, in step S412, the result of recent 50 traveling distance data can be obtained in addition to the total traveling distance data up to now.

When the number N becomes equal to the set N_{Max}, i.e., when it is judged that N=N_{Max}, the routine proceeds to step S411, in which arithmetic processing is performed such that N=N_{Max}−1, and then the routine proceeds to step S412. Unless it is judged in step S410 that N=N_{Max}, the routine proceeds to step S412. By the processing in this step, the recent N_{Max} data are updated every time the vehicle travels, thereby obtaining the composing ratios PL₁ for the recent N_{Max}.

In next step S412, the same processing as that in FIG. 4 is performed, thus making a histogram of the traveling distance parameter vs. the composing ratio with respect to the recent N_{Max} traveling distance data inclusive of this data.

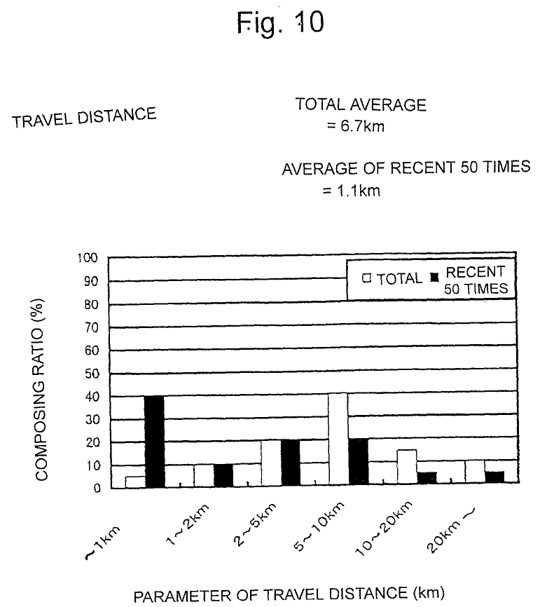

FIG. 10 illustrates an example of a histogram of the traveling distance parameter vs. the composing ratio and the average traveling distance, in which N_{Max} is set to be 50. Since the histogram of the traveling distance parameter vs. the composing ratio and the average traveling distance are displayed, the driver can confirm his or her driving situation in detail. Upon completion of step S412, the routine proceeds to step S304 of FIG. 3, in which the marking is performed.

In next step S304, the obtained traveling distance data are marked. Specifically, the composing ratio of the traveling distance of the vehicle is marked with respect to each of conditions of the composing ratio based on a preset point. Hereinafter, an example of a method for marking the composing ratio of the traveling distance in step S304 will be explained with reference to Table 1.

The composing ratio of the traveling distance is marked in accordance with an evaluation criterion of Table 1 based on the histogram of the traveling distance parameter vs. the composing ratio obtained by the processing routine illustrated in FIG. 4 or FIG. 14. Here, the evaluation criterion of Table 1 has been previously stored in the RAM 103. At the time of marking, the CPU 102 reads information on the evaluation criterion from the RAM 103, and then executes the marking.

Based on the frequency of using the vehicle to move a distance for which a person can walk with little need to drive the vehicle, more specifically, the composing ratio of the traveling distance of 1 km or less, it is judged whether or not the vehicle has been used in an ecologically friendly manner. Namely, a higher point can be acquired as the composing ratio of the traveling distance of 1 km or less is smaller.

TABLE 1
Histogram of traveling distance: Full mark = 25

| Evaluation | Point |
|---|---|
| Traveling distance of 1 km or less is 50% or more | 0 |
| Traveling distance of 1 km or less is 40% to 50% | 5 |
| Traveling distance of 1 km or less is 30% to 40% | 10 |
| Traveling distance of 1 km or less is 20% to 30% | 15 |
| Traveling distance of 1 km or less is 10% to 20% | 20 |
| Traveling distance of 1 km or less is 0% to 10% | 25 |

In addition to the evaluation of the traveling distance, an idling time ratio, a composing ratio of the traveling speed and an acceleration standard deviation, described later, are comprehensively marked in next step S305, thus judging the driving situation.

As a specific example, the comprehensive evaluation of the driving situation of the driver with respect to the terrestrial environment is calculated by adding the marked point to the information on each of the vehicles. The calculation of the comprehensive evaluation is performed by the CPU 102. In next step S306, the result of the calculated evaluation is output from the CPU 102, and then is notified to the driver by the display device 108 or the sound output device 109.

For example, in the CPU 102, a grade A is set for the total point of 95 or more, a grade B is set for the total point ranging from 90 to 95, a grade C is set for total point ranging from 80 to 90, a grade D is set for the total point ranging from 60 to 80, and a grade E is set for the total point of less than 60. The driver is notified of such a result of the comprehensive evaluation, and hence he or she can recognize his or her comprehensive driving situation with respect to the terrestrial environment. This can assist the driver to drive the vehicle in an ecologically friendly manner.

Here, when the evaluation result is grade D or E, a further effect can be expected by configuring the system such that the display device 108 or the sound output device 109 calls visual or auditory attention of the driver. Alternatively, the assumed patterns may be previously stored in the ROM 104, and the system may advise the driver how to improve their driving situation if the evaluation result is the grade D or E.

(Evaluation of Idling Time, Traveling Speed and Acceleration)

Next, explanation will be made on a processing routine relating to the idling time, the traveling speed and the acceleration of the vehicle, which is implemented in the navigation system 10, with reference to the drawings.

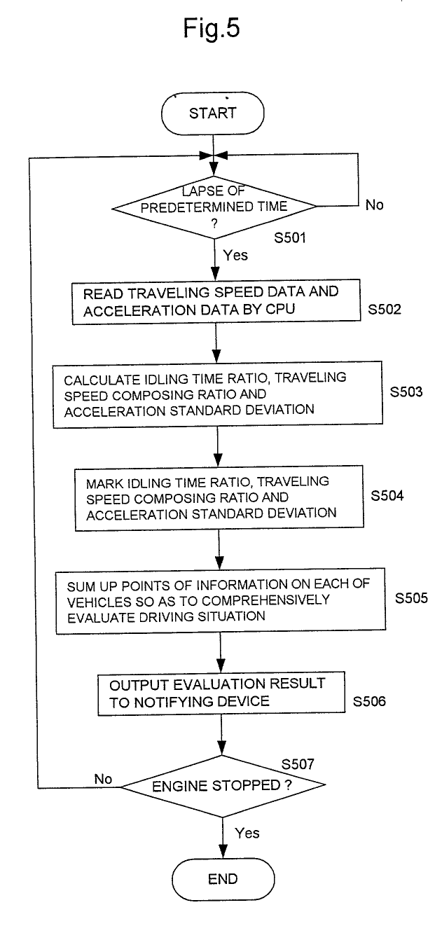

FIG. 5 is a flowchart illustrating the processing routine for evaluating the idling time, the traveling speed and the acceleration of the vehicle in the navigation system 10 of FIG. 1 according to the first preferred embodiment.

At the same time when the engine of the vehicle is started, the processing routine of FIG. 5 is implemented in the navigation system 10. After the start of the engine, it is judged in step S501 whether or not a predetermined time set previously has elapsed. Here, the predetermined time signifies a unit time which is required for obtaining the traveling speed and the acceleration of the vehicle and has been stored in the CPU 102 in advance. When a lapse of the predetermined time is confirmed, the processing routine proceeds to next step S502.

In step S502, the CPU 102 obtains the traveling speed data and the acceleration data from the vehicle speed sensor 114 and the acceleration sensor 115, respectively, via the input/output port 105 and the bus 106.

In this step, the traveling-speed data and the acceleration data during the use of the vehicle are input into the CPU 102 which performs arithmetic processing.

The traveling speed data and the acceleration data, which the CPU 102 obtained, are subjected to the arithmetic processing in step S503 in accordance with a preset routine.

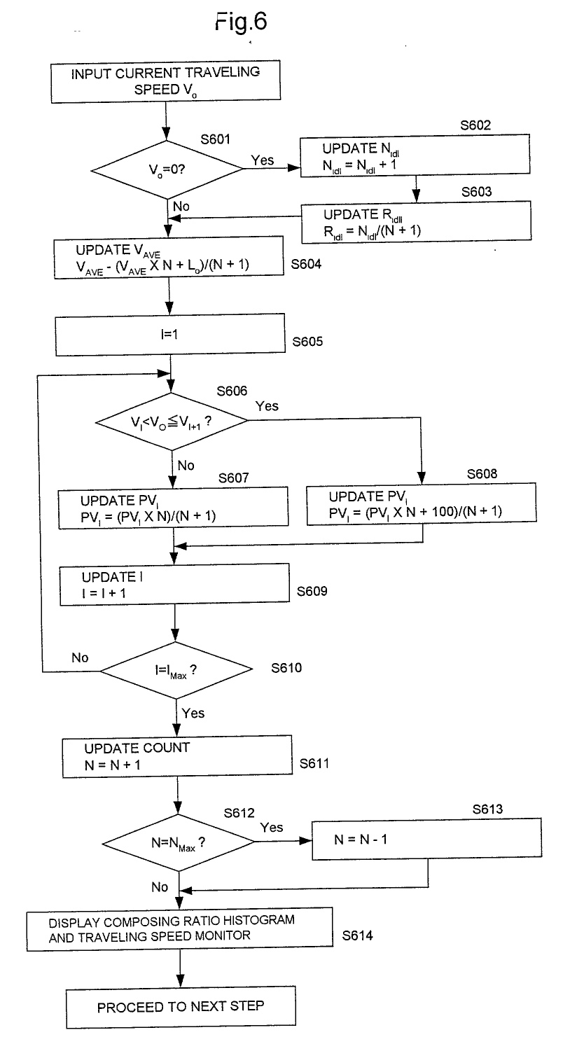

A specific example of the arithmetic processing of the traveling speed data, which is performed in step S503, will be explained in reference to FIG. 6.

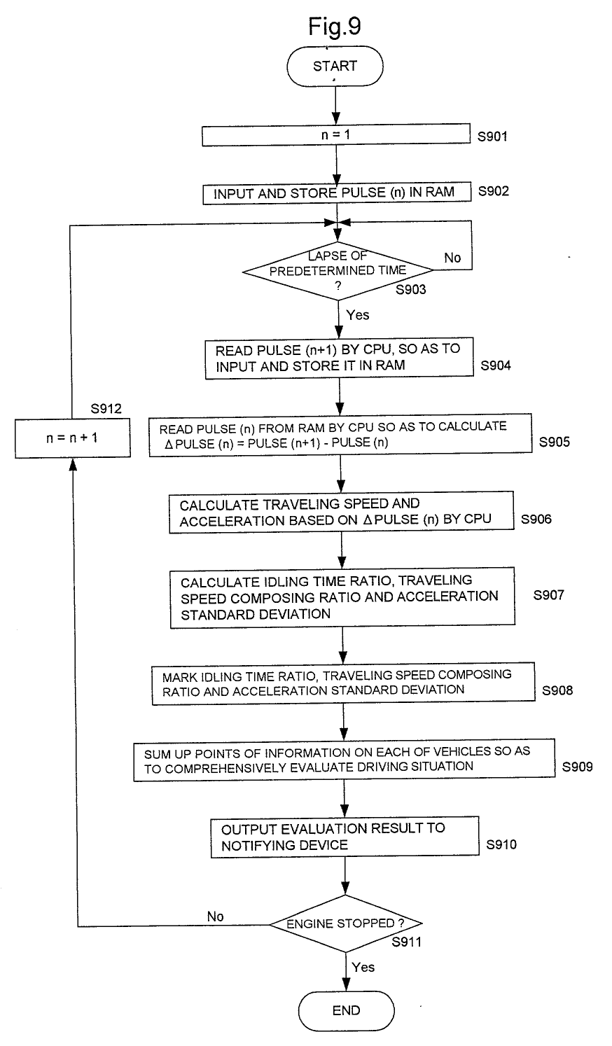

FIG. 6 is a flowchart illustrating a specific processing routine for calculating a histogram based on the classification of the traveling speed data into parameters in the CPU 102 so as to calculate a composing ratio representing the frequency of each of the parameters in the histogram in step S503 of FIG. 5 and step S907 of FIG. 9, described later, and further, a specific processing routine for calculating an idling time ratio.

It is judged in step S601 whether or not the traveling speed Vₒ obtained by the CPU 102 is 0. Namely, this step is to detect whether or not Vₒ=0, that is, the vehicle is in the idling state. In the case where Vₒ=0, it is judged that the vehicle is idling, and therefore the routine proceeds to step S602. In contrast, if Vₒ≠0, it is judged that the vehicle is traveling, and therefore the routine proceeds to step S604.

In the case where Vₒ=0, that is, the vehicle is idling, the idling time N_{idl} is updated to N_{idl}+1 in step S602, and then the routine proceeds to step S603.

In step S603, an idling time ratio R_{idl} is updated to N_{idl}/ (N+1) based on N_{idl} updated in step S602. The idling time ratio obtained in this step is to be evaluated as described later. After the idling time ratio is updated, the routine proceeds to step S604.

Here, reference character N designates the times of traveling speed data sampled from the start of the processing routine of FIG. 5 to the previous sampling.

In step S604, an average traveling speed V_{Ave} of the traveling speeds for a certain period of time is updated. The certain period of time can be freely set based on N_{Max}, described later. Calculation of the average traveling speed V_{Ave} enables the notification of an average speed of the vehicle to the driver at real time.

In next step S605, I is set to 1, wherein reference character I represents a variable required for identifying one of the classified parameters to which the traveling speed data belongs in steps after S606.

In step S606, an actual identification judgement is made as to which parameter the traveling speed data Vₒ actually belongs. Specifically, it is judged whether or not the traveling speed data Vₒ is greater than V_{I} and not greater than V_{I+1}, that is, it ranges within parameters of V_{I}<Vₒ≦V_{I+1}. In other words, it is first judged in this routine whether or not V₁<Vₒ≦V₂ based on I which is set to be 1 in step S605.

Here, in the present embodiment, it is assumed that the setting input device 111 previously sets such that, for example, a maximum value I_{Max} of I=8 and V₁=0, V₂=5, V₃=20, V₄=40, V₅=60, V₆=80, V₇=100 and V₈=120. Namely, it is judged in this routine whether or not 0<the traveling speed data Vₒ≦5.

It is noted that I_{Max} represents the total number of classified parameters. Each of V₁, V₂, . . . V_{I} represents an upper limit value and a lower limit value of the range of each of the parameters, which can be varied by the setting input device 111. V_{I+1} is desirably set to a large value since the range of the maximum parameter is expressed to be V_{I} or greater at the time of the evaluation. For example, V₉ as V_{I+1} is set to be 9999 in the present embodiment.

Subsequently, a composing ratio PV_{I} (%) of V₁ is updated in step S607 or step S608. The composing ratio PV_{I} represents the ratio of the number of parameters with respect to the total sampling number up to this sampling.

If it is judged in step S606 that Vₒ belongs to the parameters from V₁ to V₂, namely, it is judged that V₁<Vₒ≦V₂, the routine proceeds to step S608, in which the composing ratio PV_{I} of the parameter ranging within V₁<Vₒ≦V₂ is updated, and then the routine proceeds to step S609. In contrast, unless it is judged that Vₒ belongs to the parameters from V₁ to V₂, namely, unless it is judged that V₁<Vₒ≦V₂, the routine proceeds to step S607. In the same manner, the composing ratio PV_{I} of the parameter ranging within V₁<Vₒ≦V₂ is updated, and then the routine proceeds to step S609.

Here, the composing ratio PV_{I} in the case where it is judged in step S606 that the value Vₒ is greater than V₁ and not greater than V₂, namely, V₁<Vₒ≦V₂, is calculated in step S608. In contrast, the composing ratio PV_{I} in the case where it is not judged in step S606 that the value Vₒ is greater than V₁ and not greater than V₂, namely, it is not judged that V₁<Vₒ≦V₂, is calculated in step S607.

In next step S609, the value I is updated as I+1. Step 609 in which the value I is updated is a preparation step to determine the composing ratio PL_{I} of the next parameter from a next step onward. In this routine in the present embodiment, I is updated to be 2, and then the routine proceeds to next step S610.

In next step S610, it is judged whether or not the value I updated in step S609 is equal to Iₘₐₓ. If it is judged in step S610 that I=I_{Max}, it signifies that the composing ratios PV_{I} for all of the parameters has been updated. In other words, step S610 is a step in which it is judged whether or not all of the composing ratios PV_{I} to be updated have been updated. This time, it is judged that I is not equal to I_{Max} since I_{Max} is set to be 8 in the present embodiment, the routine returns to step S606.

Subsequently, in step S606 again, it is judged based on V₁<Vₒ≦V_{I+1} whether or not the traveling speed Vₒ belongs to the parameters ranging within V₂<Vₒ≦V₃. In the present embodiment, it is judged whether or not 5<Vₒ≦20.

In this manner, the routine is repeated from step S606 to step S610 until I reaches I_{Max}, that is, until the composing ratios PV_{I} of all of the parameters are updated. Consequently, the traveling speed Vₒ belongs to any one range out of V₁<Vₒ≦V₂, V₂<Vₒ≦V₃, . . . V_{Imax}<Vₒ≦V_{IMax+1}, that is, to any one parameter. Thus, each of the composing ratios PV₁, PV₂ . . . PV_{Imax} is updated in step S607 or step S608.

When it is judged in step S610 that I=I_{Max}, that is, when the composing ratios PV₁ of all of the parameters are updated, the routine proceeds to step S611.

In step S611, the total sampling number N up to the previous sampling is incremented by 1. Namely, the calculation in accordance with the expression of N=N+1 is performed, and thus N is updated as the total sampling number inclusive of this sampling.

Subsequently, the routine proceeds to step S612. In step S612, it is judged whether or not the sampling number N updated in step S611 is N_{Max}, wherein N_{Max} represents a number which is set to obtain an average traveling speed V_{Ave} of recent sampling number N_{Max} inclusive of this sampling. In other words, N_{Max} represents a number which is set to obtain an average traveling speed V_{Ave} for a certain period of time.

Here, the certain period of time can be actually obtained by multiplying a predetermined time required for obtaining the traveling speed illustrated in step S501 of FIG. 5 by the number N_{Max}. Consequently, the number N_{Max} itself can be referred to as the certain period of time. The number N_{Max} can be freely set using the setting input device 111 by the driver. Varying the number N_{Max} enables a time resolution of a traveling speed monitor to be freely varied.

In the case where it is judged that N=N_{Max}, the routine proceeds to step S613, in which arithmetic processing is performed such that N=N−1, and then the routine proceeds to step S614. Unless it is judged in step S612 that N=N_{Max}, the routine proceeds to step S614. This step is a preparation step to sequentially update the average traveling speed V_{Ave} within the set certain period of time.

In next step S614, the histogram of the traveling distance parameter vs. the composing ratio is made based on each of the composing ratios obtained from the data processed in step S601 to step S613, and the histogram is displayed on the display device 108 in the form of an image. Furthermore, the average traveling speed V_{Ave} obtained in step S604 is also displayed on the display device 108 in the form of an image as a traveling speed monitor. Here, the traveling speed monitor signifies an image in which the average traveling speed V_{Ave} with respect to the time after the start of the driving during the traveling is displayed in time sequence.

In the case where each of the images is displayed on the display device 108, the CPU 102 outputs the data to the display device 108 through the bus 106 and the input/output port 105, and the display device 108 displays the data in the form of an image.

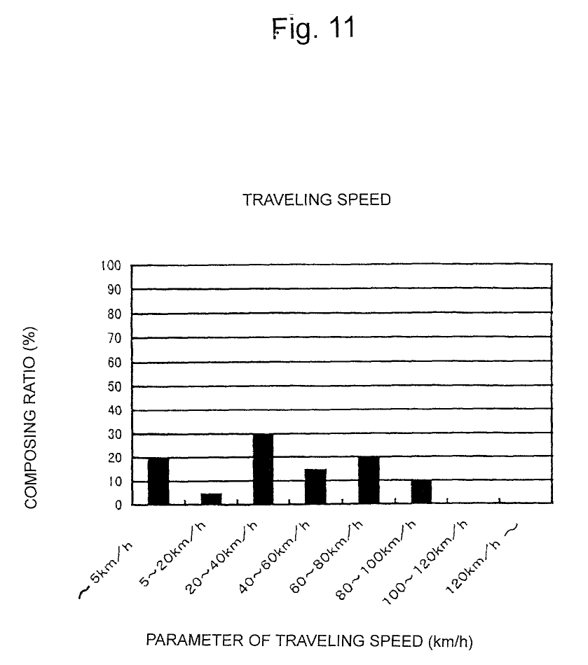

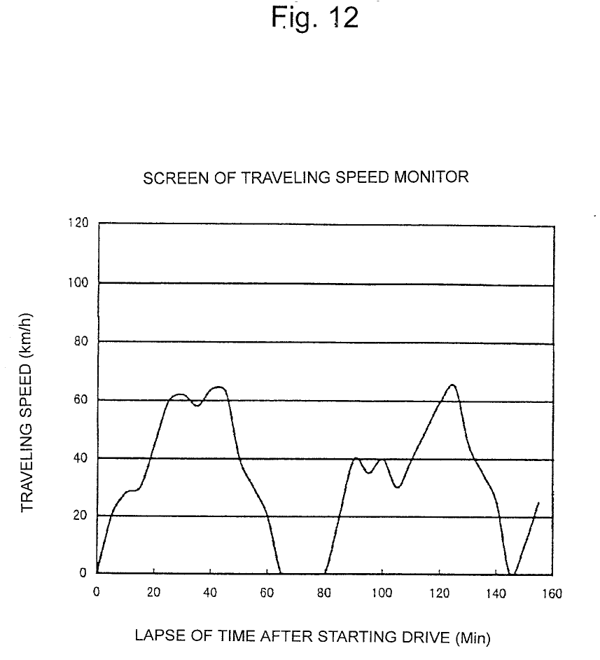

FIG. 11 illustrates an example of a histogram of the traveling speed parameter vs. the composing ratio and the average traveling speed, and FIG. 12 illustrates an example of the traveling speed monitor. In the traveling speed monitor of FIG. 12, a time when the traveling speed is 0 signifies an idling time.

Since the histogram of the traveling distance parameter vs. the composing ratio and the traveling speed monitor are displayed, the driver can confirm his or her driving situation in detail.

Upon completion of step S614, the routine proceeds to step S504 of FIG. 5.

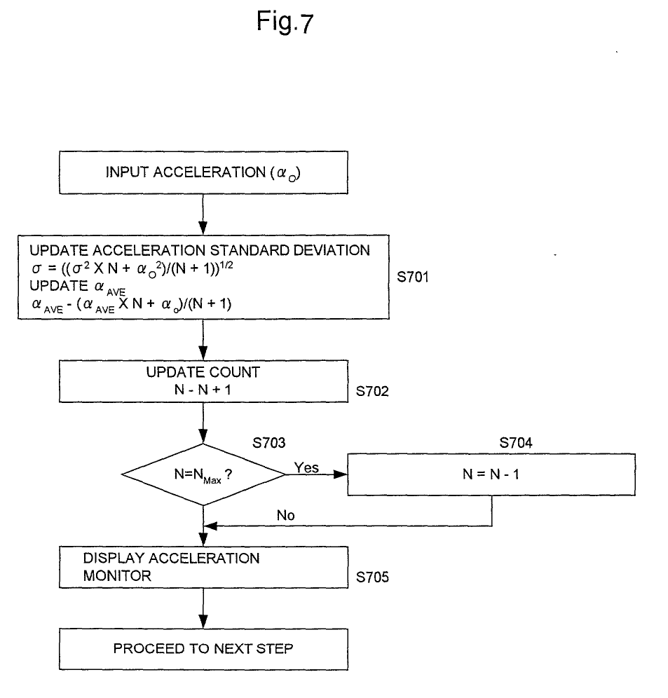

Next, a specific example of the processing of the acceleration data, which is performed in step S503, will be explained in reference to FIG. 7.

FIG. 7 is a flowchart illustrating a specific processing routine in which the CPU 102 calculates an acceleration standard deviation based on the acceleration data in step S503 of FIG. 5 and step S907 of FIG. 9 in a second embodiment described later.

In step S701, an acceleration standard deviation σ is updated based on the acceleration αₒ read by the CPU 102. It is found that the greater the acceleration standard deviation σ is, the higher the frequency of fast acceleration or deceleration. Here, the reference character N designates the number of acceleration data sampled from the start of the processing routine of FIG. 5 to the previous sampling.

Furthermore, in step S701, an average acceleration α_{Ave} of the accelerations for a certain period of time is also updated based on the acceleration αₒ read by the CPU 102. The certain period of time can be freely set based on N_{Max} described later. Calculation of the average acceleration α_{Ave} enables the average acceleration of the vehicle to be notified to the driver at real time. After the acceleration standard deviation σ and the average acceleration α_{Ave} are updated; the processing routine proceeds to step S702.

In step S702, the total sampling number N up to the previous sampling is incremented by 1. Namely, the calculation in accordance with the expression of N=N+1 is performed, and thus N is updated as the total sampling number inclusive of this sampling.

Subsequently, the routine proceeds to step S703. In step S703, it is judged whether or not the sampling number N updated in step S702 is equal to N_{Max}, wherein N_{Max}, represents a number which is set to obtain the average acceleration α_{Ave} of the recent sampling number N_{Max} inclusive of this sampling. In other words, N_{Max} represents a number which is set to obtain the average acceleration α_{Ave} for a certain period of time.

Here, the certain period of time can be actually obtained by multiplying a predetermined time required for obtaining the acceleration illustrated in step S501 of FIG. 5 by the number N_{Max}. Consequently, the number N_{Max} itself can be referred to as the certain period of time. The number N_{Max} can be freely set in the setting input device 111 by the driver. Varying the number N_{Max} enables a time resolution of an acceleration monitor to be freely varied.

In the case where it is judged that N=N_{Max}, the routine proceeds to step S704, in which arithmetic processing is performed such that N=N−1, and then the routine proceeds to step S705. Unless it is judged in step S703 that N=N_{Max}, the routine proceeds to step S705. This step is a preparation step to sequentially update the average acceleration α_{Ave} within the set certain period of time.

In next step S705, the average acceleration α_{Ave} based on the data processed in step S701 to step S704 is displayed on the display device 108 in the form of an image as an acceleration monitor. Here, the acceleration monitor signifies an image in which the average acceleration α_{Ave} with respect to the time after the start of the driving during the traveling is displayed in time sequence.

In this case, the CPU 102 outputs the data to the display device 108 through the bus 106 and the input/output port 105, and then the display device 108 displays the data in the form of an image.

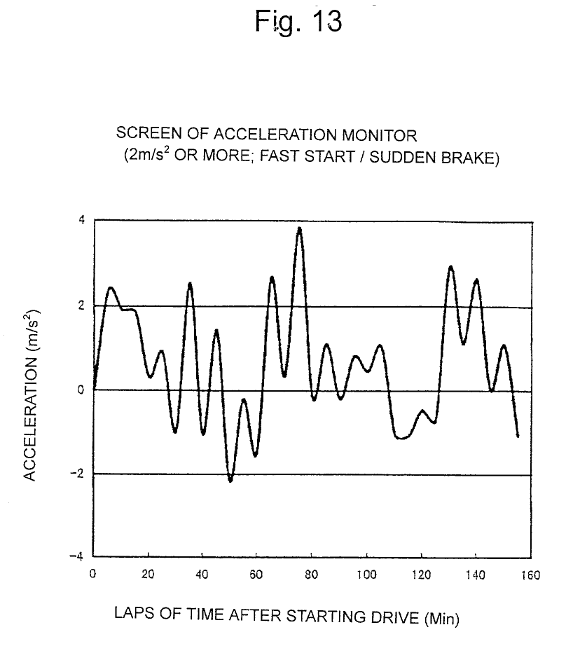

FIG. 13 illustrates an example of the acceleration monitor. Since the acceleration monitor is displayed, the driver can confirm his or her driving situation in detail. Upon completion of the processing in step S705, the routine proceeds to step S504 of FIG. 5.

After the processing routines in FIGS. 6 and 7, the obtained traveling speed data, the acceleration data and the idling data are marked in next step S504.

Specifically, in the case of the traveling speed data, the composing ratio of the traveling speed of the vehicle is marked with respect to each of conditions of the composing ratio based on a preset point. In the case of the acceleration data, the acceleration standard deviation of the vehicle is marked with respect to each of conditions of the acceleration standard deviation based on a preset point. In the case of the idling data, the idling time ratio of the vehicle is marked with respect to each of conditions of the idling time ratio based on a preset point. Hereinafter, an example of a method for marking the composing ratio of the traveling speed, the acceleration standard deviation and the idling time ratio in step S504 will be explained with reference to Tables.

The idling time ratio is marked in accordance with an evaluation criterion of Table 2 based on the data on the idling time ratio obtained by the processing routine illustrated in FIG. 6. Here, the evaluation criterion of Table 2 has been previously stored in the RAM 103. At the time of marking, information on the evaluation criterion is output from the RAM 103, and then the CPU 102 executes the marking.

Fuel consumption is increased if the idling time is long, thereby exerting an adverse influence on the terrestrial environment. Consequently, it is designed such that the lower the idling time ratio is, the higher the point is.

In the present embodiment, the idling time ratio is calculated for marking. However, such a method may be used that the total idling time is calculated, an evaluation criterion for marking an idling time, like Table 2, is set, and thus the total idling time is marked in accordance with the evaluation criterion.

TABLE 2
Idling time ratio: Full mark = 25

| Evaluation | Point |
|---|---|
| 50% or more | 0 |
| 40% to 50% | 5 |
| 30% to 40% | 10 |
| 20% to 30% | 15 |
| 10% to 20% | 20 |
| 0% to 10% | 25 |

The composing ratio of the traveling speed is marked in accordance with an evaluation criterion of Table 3 based on the histogram of the traveling speed parameter vs. the composing ratio obtained by the processing routine illustrated in FIG. 6. Here, the evaluation criterion of Table 3 has been previously stored in the RAM 103. At the time of marking, the CPU 102 reads information on the evaluation criterion from the RAM 103, and then executes the marking.

An engine speed becomes higher during the traveling at a high speed, and thus fuel consumption is increased, thereby exerting an adverse influence on the terrestrial environment. Furthermore, mobility is poor during the traveling at a low speed, and thus the fuel consumption is increased, thereby exerting an adverse influence on the terrestrial environment. In view of these facts, the evaluation criterion is set.

Each of the vehicles has an efficient traveling speed peculiar to itself, at which it can travel at a low engine speed with low fuel consumption. It may be designed such that a higher point is marked as the traveling speed ratio becomes higher. Since the efficient traveling speed is varied according to the type of vehicle, the evaluation criterion per type of vehicle is variably set by using the setting input device 111.

TABLE 3
Histogram of traveling speed: Full mark = 25

| Evaluation | Point |
|---|---|
| Traveling speed of 120 km/h or higher is 50% or more | 0 |
| Traveling speed of 5 km/h or higher is 50% or more | 0 |
| Traveling speed of 5 km/h or higher is 40% to 50% | 5 |
| Traveling speed of 5 km/h or higher is 30% to 40% | 10 |
| Traveling speed of 5 km/h or higher is 20% to 30% | 15 |
| Traveling speed of 5 km/h or higher is 10% to 20% | 20 |
| Traveling speed of 5 km/h or higher is 0% to 10% | 25 |

The acceleration standard deviation is marked in accordance with an evaluation criterion of Table 4 based on the data on the acceleration standard deviation obtained by the processing routine illustrated in FIG. 7. Here, the evaluation criterion of Table 4 has been previously stored in the RAM 103. At the time of marking, the CPU 102 reads information on the evaluation criterion from the RAM 103, and then executes the marking.

The greater the acceleration standard deviation is, the higher the rate of fast acceleration is. The fast acceleration unnecessarily increases an engine speed, and thus fuel consumption is increased, thereby exerting an adverse influence on the terrestrial environment. It is designed such that a higher point is marked as the acceleration standard deviation becomes smaller.

In the present embodiment, the acceleration standard deviation is calculated for marking. However, such a method may be used that the composing ratio of the acceleration is calculated in the same manner as the traveling speed, an evaluation criterion for marking the composing ratio of the acceleration, like Table 4, is set, and thus the composing ratio of the acceleration is marked in accordance with the evaluation criterion.

TABLE 4
Acceleration standard deviation: Full mark = 25

| Evaluation | Point |
|---|---|
| 1.1 m/s² or more | 0 |
| 0.9 m/s² or more and less than 1.1 m/s² | 5 |
| 0.8 m/s² or more and less than 0.9 m/s² | 10 |
| 0.7 m/s² or more and less than 0.8 m/s² | 15 |
| 0.6 m/s² or more and less than 0.7 m/s² | 20 |
| less than 0.6 m/s² | 25 |

In next step S505, the driving situation is judged by comprehensively marking the traveling distance composing ratio, which is obtained till the previous traveling, in addition to the traveling speed composing ratio, the acceleration standard deviation and the idling time ratio.

As a specific example, the comprehensive evaluation of the driving situation of the driver with respect to the terrestrial environment is calculated by adding the marked point to the information on each of the vehicles. The calculation of the comprehensive evaluation is performed by the CPU 102. In next step S506, the result of the calculated evaluation is output from the CPU 102, and then is notified to the driver by the display device 108 or the sound output device 109.

In the CPU 102 have been previously set a grade A in the case of a total point of 95 or more, a grade B in the case of a total point ranging from 90 to 95, a grade C in the case of a total point ranging from 80 to 90, a grade D in the case of a total point ranging from 60 to 80, and a grade E in the case of a total point of less than 60, as an example of the comprehensive evaluation.

The driver is notified of such a result of the comprehensive evaluation, and can recognize his or her comprehensive driving situation with respect to the terrestrial environment. This can assist the driver to drive the vehicle in an ecologically friendly manner.

Here, in the case of the evaluation result of D or E, a further effect can be expected by configuring a system such that the display device 108 or the sound output device 109 calls visual or auditory attention of the driver.

Alternatively, assumed patterns have been previously stored in the ROM 104, the driver may be advised how to cope with his or her driving situation so as to improve the driving situation in the case of the evaluation result of D or E.

In next step S507, it is judged whether or not the engine of the vehicle is stopped. The engine stoppage leads to completion of inputting of the traveling speed data and the acceleration data into the CPU 102. Upon confirmation of the engine stoppage, the present processing routine comes to an end. In contrast, unless the engine stoppage is judged, the processing routine returns to step S501, and then repeats from step S501 to step S507. Until the engine stoppage is confirmed, the processing routine is repeated. The evaluation result is continuously updated, and then is notified to the driver by the display device 108 or the sound output device 109.

In the present embodiment, the driving situation is judged by comprehensively marking the respective points of the traveling distance composing ratio, the traveling speed composing ratio, the acceleration standard deviation and the idling time. However, only the marking result of each of the vehicle information may be notified to the driver by the display device 108 or the sound output device 109.

[Second Embodiment]

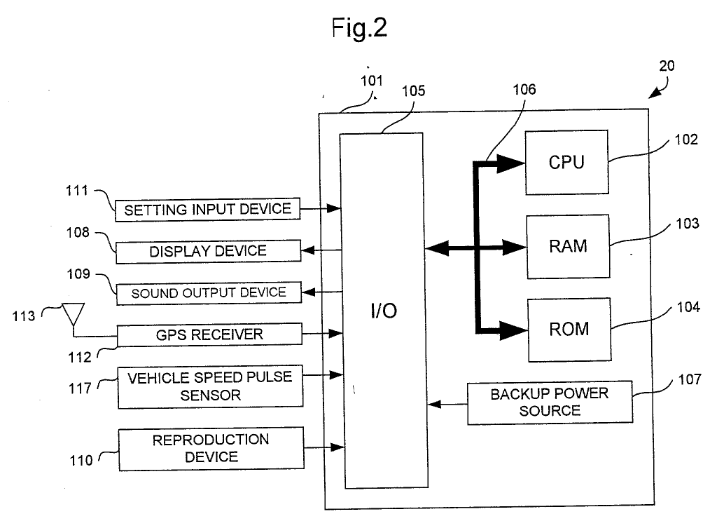

In a second embodiment, a vehicle speed pulse sensor 117 may be connected to an input/output port 105 in a navigation system 20 illustrated in FIG. 2 in place of the vehicle speed sensor 114, the acceleration sensor 115 and the traveling distance sensor 116 illustrated in FIG. 1. In this embodiment, a traveling speed, an acceleration and a traveling distance during traveling of a vehicle can be detected based on a vehicle speed pulse output from the vehicle speed pulse sensor 117.

(Evaluation of Traveling Distance)

Next, explanation will be made below on a processing routine relating to the traveling distance of the vehicle to be executed in the navigation system 20 with reference to the drawings.

FIG. 8 is a flowchart illustrating the processing routine for evaluating the traveling distance of the vehicle in the navigation system 20 of FIG. 2 according to the second embodiment.

The processing routine illustrated in FIG. 8 is started in the navigation system 20 simultaneously with the start of the engine of the vehicle. Immediately after starting the engine, the vehicle speed pulse data output from the vehicle speed pulse sensor 117 is input as a Pulse (1) into the RAM 103 via the input/output port 105 and a bus 106 in step S801.

The Pulse (1) is the vehicle speed pulse which is output from the vehicle speed pulse sensor 117 at the time of the start of the engine. The Pulse (1) is data required for calculating a traveling distance in each driving of the vehicle, and therefore it is input into and then stored in the RAM 103.

It is judged in step S802 whether or not the engine of the vehicle is stopped. The time when the stoppage of the engine is detected signifies a lapse of a predetermined time when traveling distance data is detected. Upon confirmation of the stoppage of the engine, the routine proceeds to next step S803.

In step 803, the CPU 102 reads, as a Pulse (2), the vehicle speed pulse data output from the vehicle speed pulse sensor 117 via the input/output port 105 and the bus 106.

The Pulse (2) is a vehicle speed pulse to be output from the vehicle speed pulse sensor 117 immediately after the stoppage of the engine. The Pulse (2) is also the data required for calculating the traveling distance data per driving of the vehicle.

Here, in the processing routine of FIG. 8, the times of the start of the engine and the stoppage of the engine are set as predetermined times which are input by the CPU 102.

In next step S804, the CPU 102 calculates a difference between the Pulse (1) and the Pulse (2), i.e., a ΔPulse. At this time, the CPU 102 reads, from the RAM 103, the Pulse (1) stored in the RAM 103. In this manner, the ΔPulse is calculated.

In next step S805, the CPU 102 calculates a traveling distance based on the ΔPulse. In a specific method, the traveling distance is calculated by multiplying a distance constant, which is peculiarly set for each of the vehicles, by the ΔPulse. The distance constant signifies a circumference of a wheel of the vehicle. Namely, the distance constant indicates the distance that the vehicle advances by one rotation of its wheel. The traveling distance data per driving is calculated by multiplying the total number of rotations of an axle of the vehicle during traveling, that is, the ΔPulse by the distance constant.

The traveling distance data calculated in step S805 is classified into parameters corresponding to the data out of preset parameters in the CPU 102 in next step S806, and thus the composing ratio of each of the parameters is updated. In a specific example, such classification is performed in accordance with the same routine as that in step S303 of FIG. 3 in the first embodiment, that is, in accordance with the processing routine illustrated in FIG. 4 or FIG. 14.

In next step S807, the obtained traveling distance data is marked. Specifically, the composing ratio of the traveling distance of the vehicle is marked with respect to each of conditions of the composing ratio based on a preset point. Hereinafter, the explanation will be made on an example of a method for marking the composing ratio of the traveling distance in step S807.

The composing ratio of the traveling distance is marked in accordance with the evaluation criterion of Table 1 based on the histogram of the traveling distance parameter vs. the composing ratio obtained by the processing routine illustrated in FIG. 4 or FIG. 14 in the same manner as in the first embodiment. Here, the evaluation criterion of Table 1 has been previously stored in the RAM 103. At the time of marking, the CPU 102 reads information on the evaluation criterion from the RAM 103, and then executes the marking.

Based on the composing ratio of a vehicle using frequency at a traveling distance of 1 km or less with little need to drive the vehicle, it is judged whether or not the vehicle has been used in an ecologically friendly manner. Namely, a higher point can be acquired as the composing ratio of a traveling distance of 1 km or less is smaller.

In addition to the evaluation of the traveling distance, an idling time ratio, a composing ratio of the traveling speed and an acceleration standard deviation are comprehensively marked in-next step S808, thus judging the driving situation.

As a specific example, the comprehensive evaluation of the driving situation of the driver with respect to the terrestrial environment is calculated by adding the marked point to the information on each of the vehicles. The calculation of the comprehensive evaluation is performed by the CPU 102. In next step S809, the result of the calculated evaluation is output from the CPU 102, and then is notified to the driver by the display device 108 or the sound output device 109.

In the CPU 102 have been previously set a grade A for the total point of 95 or more, a grade B for the total point ranging from 90 to 95, a grade C for the total point ranging from 80 to 90, a grade D for the total point ranging from 60 to 80, and a grade E for the total point of less than 60 as an example of the comprehensive evaluation.

The driver is notified of such a result of the comprehensive evaluation, and thus can recognize his or her comprehensive driving situation with respect to the terrestrial environment. This can assist the driver to drive the vehicle in an ecologically friendly manner.

Here, in the case of the evaluation result of D or E, a further effect can be expected by configuring a system such that the display device 108 or the sound output device 109 calls visual or auditory attention of the driver.

Alternatively, assumed patterns may be previously stored in the ROM 104 so that the driver may be advised how to cope with his or her driving situation so as to improve the driving situation in the case of the evaluation result of D or E.

(Evaluation of Idling Time, Traveling Speed and Acceleration)

Next, explanation will be made on a processing routine relating to the idling time, the traveling speed and the acceleration of the vehicle, which is implemented in the navigation system 20, with reference to the drawings.

FIG. 9 is a flowchart illustrating the processing routine for evaluating the traveling speed, the acceleration and the idling time of the vehicle in the navigation system 20 of FIG. 2 according to the second preferred embodiment.

At the same time when the engine of the vehicle is started, the processing routine of FIG. 9 is implemented in the navigation system 20. Immediately after starting the engine, n is defined to be 1 in step S901. Here, n is a variable representing the input order of the Pulse, which is output from the vehicle speed pulse sensor 117, and then input into the navigation system 20.

In step S902, the vehicle speed pulse data output from the vehicle speed pulse sensor 117 is input, as a Pulse (n), into the RAM 103 via the input/output port 105 and the bus 106. Here, since n=1, the vehicle speed pulse data is input as the Pulse (1). The Pulse (1) is data required for calculating the traveling speed and the acceleration of the vehicle, and therefore it is input into and then stored in the RAM 103.

It is judged in next step S903 whether or not a predetermined time set previously elapses. Here, the predetermined time signifies a unit time required for obtaining the traveling speed and the acceleration of the vehicle. When the lapse of the predetermined time is confirmed, the processing routine proceeds to next step S904.

In step S904, the CPU 102 reads the vehicle speed pulse data, as a Pulse (n+1), from the vehicle speed pulse sensor 117 via the input/output port 105 and the bus 106. Here, since n=1, the vehicle speed pulse data is input as the Pulse (2).

The Pulse (2) is data required for calculating a ΔPulse (2), which is needed in the following steps, and therefore it is input into and then stored in the RAM 103.

The Pulse (2) is also the data required for calculating the traveling speed and the acceleration of the vehicle.

In next step S905, the CPU 102 first reads, from the RAM 103, the Pulse (n) stored in the RAM 103, which is the Pulse (1) here since n =1. Then, after the Pulse (n) is output from the RAM 103, the value stored in the RAM 103 is erased thereafter.

Subsequently, the CPU 102 calculates a difference between the Pulse (n+1) and the Pulse (n), i.e., a ΔPulse (n), wherein the CPU 102 calculates a ΔPulse (1) since n=1.

In next step S906, the CPU 102 calculates a traveling speed and an acceleration based on the ΔPulse (n). In a specific method, the traveling distance is calculated by multiplying a distance constant, which is set peculiarly to each of the vehicles, by the ΔPulse (n). The distance constant signifies a circumference of a wheel of the vehicle. The traveling distance data per unit time is calculated by multiplying the total number of rotations of an axle of the vehicle during traveling, that is, the ΔPulse (n) by the distance constant.

The traveling speed is calculated by differentiating the calculated traveling distance with respect to a unit time, and further the acceleration is calculated by differentiating the calculated traveling speed with respect to the unit time.

The traveling speed data calculated in step S906 is classified into parameters corresponding to the data out of preset parameters in the CPU 102 in next step S907, and thus the composing ratio of each of the parameters is updated. In a specific example, such classification is performed in accordance with the same routine as that in step S503 of FIG. 5 in the first embodiment, that is, in accordance with the processing routine illustrated in FIG. 6. Also with respect to idling time data, an idling time ratio is updated in accordance with the processing routine illustrated in FIG. 6 in the same manner as in the first embodiment.

Moreover, the CPU 102 updates an acceleration standard deviation in next step S907 based on the acceleration data calculated in step S906. In a specific example, the acceleration standard deviation is processed in accordance with the same routine as that in step S503 in the first embodiment, that is, in accordance with the processing routine illustrated in FIG. 7.

The obtained traveling speed data, acceleration data and idling data are marked in next step S908. Specifically, in the case of the traveling speed data, the composing ratio of the traveling speed of the vehicle is marked with respect to each of conditions of the composing ratio based on a preset point. In the case of the acceleration data, the acceleration standard deviation of the vehicle is marked with respect to each of conditions of the acceleration standard deviation based on a preset point. In the case of the idling data, the idling time ratio of the vehicle is marked with respect to each of conditions of the idling time ratio based on a preset point.

The idling time ratio is marked in accordance with the evaluation criterion of Table 2 based on the data on the idling time ratio obtained by the processing routine illustrated in FIG. 6 in the same manner as in the first embodiment. Here, the evaluation criterion of Table 2 has been previously stored in the RAM 103. At the time of marking, information on the evaluation criterion is output from the RAM 103, and then the CPU 102 executes the marking.

Fuel consumption is increased if the idling time is long, thereby exerting an adverse influence on the terrestrial environment. Consequently, it is designed such that the lower the idling time ratio is, the higher the point is.

The composing ratio of the traveling speed is marked in accordance with the evaluation criterion of Table 3 based on the histogram of the traveling speed parameter vs. the composing ratio obtained by the processing routine illustrated in FIG. 6 in the same manner as in the first embodiment. Here, the evaluation criterion of Table 3 has been previously stored in the RAM 103. At the time of marking, the CPU 102 reads information on the evaluation criterion from the RAM 103, and then executes the marking.

An engine speed becomes higher during the traveling at a high speed, and thus fuel consumption is increased, thereby exerting an adverse influence on the terrestrial environment. Furthermore, mobility is poor during the traveling at a low speed, and thus the fuel consumption is increased, thereby exerting an adverse influence on the terrestrial environment. In view of these facts, the evaluation criterion is set.

Each of the vehicles has an efficient traveling speed peculiar to itself, at which it can travel at a low engine speed with low fuel consumption. It may be designed such that a higher point is marked as the traveling speed ratio at that traveling speed becomes higher. Since the traveling speed varies according to the type of vehicle, the evaluation criterion per type of vehicle is variably set by using a setting input device 111.

The acceleration standard deviation is marked in accordance with the evaluation criterion of Table 4 based on the data on the acceleration standard deviation obtained by the processing routine illustrated in FIG. 7 in the same manner as in the first embodiment. Here, the evaluation criterion of Table 4 has been previously stored in the RAM 103. At the time of marking, the CPU 102 reads information on the evaluation criterion from the RAM 103, and then executes the marking.

The greater the acceleration standard deviation is, the higher the rate of fast acceleration is. The fast acceleration increases an engine speed more than needed, and thus fuel consumption is increased, thereby exerting an adverse influence on the terrestrial environment. It is designed such that a higher point is marked as the acceleration standard deviation becomes smaller.

In next step S909, the driving situation is judged by comprehensively marking the traveling distance composing ratio, which is obtained till the previous traveling, in addition to the traveling speed composing ratio, the acceleration standard deviation and the idling time ratio.

As a specific example, the comprehensive evaluation of the driving situation of the driver with respect to the terrestrial environment is calculated by adding the marked point to the information on each of the vehicles. The calculation of the comprehensive evaluation is performed by the CPU 102. In next step S910, the result of the calculated evaluation is output from the CPU 102, and then is notified to the driver by the display device 108 or the sound output device 109.

In the CPU 102 have been previously set a grade A for the total point of 95 or more, a grade B for the total point ranging from 90 to 95, a grade C for the total point ranging from 80 to 90, a grade D for the total point ranging from 60 to 80, and a grade E for the total point of less than 60 as an example of the comprehensive evaluation.

The driver is notified of such a result of the comprehensive evaluation, and thus can recognize his or her comprehensive driving situation with respect to the terrestrial environment. This can assist the driver to drive the vehicle in an ecologically friendly manner.

Here, in the case of the evaluation result of D or E, a further effect can be expected by configuring a system such that the display device 108 or the sound output device 109 calls visual or auditory attention of the driver.

Alternatively, assumed patterns may be previously stored in the ROM 104 so that the driver may be advised how to cope with his or her driving situation so as to improve the driving situation in the case of the evaluation result of D or E.

In next step S911, it is judged whether or not the engine of the vehicle is stopped. The engine stoppage leads to completion of inputting of the vehicle speed pulse data into the CPU 102. Upon confirmation of the engine stoppage, the present processing routine comes to an end. In contrast, unless the engine stoppage is judged, it is defined in step S912 that n=n+1, and then the processing routine returns to step S903. Thereafter, the processing routine repeats from step 903 to step S911. With the processing in step S912, the value n in the Pulse and the ΔPulse also is updated from a next step onward. Until the engine stoppage is confirmed, the processing routine is repeated. The evaluation result is continuously updated, and then is notified to the driver by the display device 108 or the sound output device 109.

In the present embodiment, the driving situation is judged by comprehensively marking the respective points of the traveling distance composing ratio, the traveling speed composing ratio, the acceleration standard deviation and the idling time. However, only the marking result of each of the vehicle information may be notified to the driver by the display device 108 or the sound output device 109.

Although the navigation system for offering the route assisting information to the driver via the image or the sound has been exemplified in the present embodiments, the present invention is not restricted to the above-described embodiments as long as a system includes a method in which the driving situation of the driver with respect to the terrestrial environment is evaluated, and then it is notified to the driver via the image display or the sound.

Moreover, although the conditions of the parameters of the information on each of the vehicles, the point set for the parameter and the point set for the comprehensive evaluation have been described in the present embodiments, the conditions are not restricted to those in the present embodiments as long as a method is used in which the driving situation of the driver with respect to the terrestrial environment is evaluated, and then it is notified to the driver via the image display or the sound. The conditions may be set according to the type of vehicle or the environment in which the vehicle is driven.

Additionally, although the RAM and the ROM are configured independently of each other inside of the navigation system in the above-described embodiments, it is understood that the ROM may be replaced with the RAM, or that the RAM and the ROM may be configured integrally with each other.

According to the present invention, the driving situation is evaluated as to whether or not the driver drives the vehicle in an ecologically friendly manner, and then the driver is notified of the evaluation result. Thus, the driver can recognize the ecologically friendly driving manner, and is assisted to drive the vehicle in an ecologically friendly manner.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Applications No. 2000-298389 filed on Sep. 29, 2000 including the specification, claims, drawings and summary is incorporated herein by reference in its entirety.

What is claimed is:

1. An information offering method for a vehicle comprising the steps of:
calculating a histogram of vehicle information or a standard deviation during use of a vehicle based on at least one of vehicle information relating to fuel consumption of the vehicle, the vehicle information being output from a vehicle information detector when a predetermined time elapses after a beginning of the use of the vehicle;
marking the vehicle information based on a point set in the histogram or the standard deviation; and
calculating an evaluation result based on the point of each of the marked vehicle information to notify a driver of the calculated evaluation result.

2. An information offering method for a vehicle as claimed in claim 1, wherein the evaluation result comprises an evaluation result of the driving situation of the vehicle.

3. An information offering method for a vehicle as claimed in claim 1, wherein the vehicle information detector comprises at least any one of a vehicle speed sensor, an acceleration sensor and a distance sensor.

4. An information offering method for a vehicle as claimed in claim 1, wherein the vehicle information comprises at least any one of a traveling distance, an idling time, a traveling speed and an acceleration of the vehicle.

5. An information offering method for a vehicle as claimed in claim 1, wherein the marking of the vehicle information is performed in consideration of the quantity of fuel consumption, the quantity of exhaust gas to be emitted, or components of the exhaust gas of the vehicle during the use of the vehicle.

6. An information offering method for a vehicle comprising the steps of:
detecting a first vehicle speed pulse output from a vehicle speed pulse sensor during use of a vehicle and a second vehicle speed pulse output from the vehicle speed pulse sensor when a predetermined time elapses after the beginning of the use of the vehicle;
calculating a histogram of vehicle information or a standard deviation based on at least one of vehicle information relating to fuel consumption of the vehicle from the first vehicle speed pulse and the second vehicle speed pulse;
marking the vehicle information based on a point set in the histogram or the standard deviation; and
calculating an evaluation result based on the point of each of the marked vehicle information to notify a driver of the calculated evaluation result.

7. An information offering method for a vehicle as claimed in claim 6, wherein the evaluation result comprises an evaluation result of the driving situation of the vehicle.

8. An information offering method for a vehicle as claimed in claim 6, wherein the vehicle information comprises at least any one of a traveling distance, an idling time, a traveling speed and an acceleration of the vehicle.

9. An information offering method for a vehicle as claimed in claim 6, wherein the marking of the vehicle information is performed in consideration of the quantity of fuel consumption, the quantity of exhaust gas to be emitted, or components of the exhaust gas of the vehicle during the use of the vehicle.

10. An information offering apparatus for a vehicle comprising:
a device for setting at least one piece of vehicle information relating to fuel consumption of a vehicle, the vehicle information being output from a vehicle information detector when a predetermined time elapses after the beginning of use of the vehicle;
a device for calculating a histogram of vehicle information or a standard deviation during the use of the vehicle based on the set vehicle information;
a device for marking the vehicle information based on a point set in the histogram or the standard deviation;
a device for calculating an evaluation result based on the point of each of the marked vehicle information; and
an notifying device for notifying a driver of the evaluation result.

11. An information offering apparatus for a vehicle as claimed in claim 10, wherein the notifying device comprises at least either one of a display and a sound output unit mounted on the vehicle.

12. An information offering apparatus for a vehicle as claimed in claim 10, wherein the evaluation result comprises an evaluation result of the driving situation of the vehicle.

13. An information offering apparatus for a vehicle as claimed in claim 10, wherein the vehicle information detector comprises at least any one of a vehicle speed sensor, an acceleration sensor and a distance sensor.

14. An information offering apparatus for a vehicle as claimed in claim 10, wherein the vehicle information comprises at least any one of a traveling distance, an idling time, a traveling speed and an acceleration of the vehicle.

15. An information offering apparatus for a vehicle comprising:
a device for detecting a first vehicle speed pulse output from a vehicle speed pulse sensor during use of a vehicle and a second vehicle speed pulse output from the vehicle speed pulse sensor when a predetermined time elapses after the beginning of the use of the vehicle;
a device for calculating a histogram of vehicle information or a standard deviation based on at least one of vehicle information relating to fuel consumption of the vehicle from the first vehicle speed pulse and the second vehicle speed pulse;
a device for marking the vehicle information based on a point set in the histogram or the standard deviation;
a device for calculating an evaluation result based on the point of each of the marked vehicle information; and
an notifying device for notifying a driver of the evaluation result.

16. An information offering apparatus for a vehicle as claimed in claim 15, wherein the notifying device comprises at least either one of a display and a sound output unit mounted on the vehicle.

17. An information offering apparatus for a vehicle as claimed in claim 15, wherein the evaluation result comprises an evaluation result of the driving situation of the vehicle.

18. An information offering apparatus for a vehicle as claimed in claim 15, wherein the vehicle information comprises at least any one of a traveling distance, an idling time, a traveling speed and an acceleration of the vehicle.
